(19) United States
(12) Patent Application Publication
(10) Pub. No.: US 2004/0221697 A1
(43) Pub. Date: Nov. 11, 2004

(54) Spindle assembly having matched end-face contact bosses

(76) Inventors: Florian I. Nowak, Newington, CT (US); Gary F. Nowak, Newington, CT (US); Jay P. Giblin, Cheshire, CT (US)

Correspondence Address: Ira S. Dorman, Suite 200, 330 Roberts Street, East Hartford, CT, 06108, US

(21) Appl. No.: 10/696,271

(22) Filed: Oct. 29, 2003

Related U.S. Application Data
(60) Provisional application No. 60/423,098, filed on Nov. 1, 2002.

(51) Int. Cl. B23B 3/34; B23B 21/00

(52) U.S. Cl. 82/129; 82/133

(57) ABSTRACT

At least one component of a spindle assembly has matched bosses disposed to the opposite sides of a transversely extending, axially offset coupling recess or key, for balance of the forces acting therealong.

### CROSS-REFERENCE TO RELATED APPLICATION

This application claims the benefit of Provisional Application No. 60/423,098, filed Nov. 1, 2002 in the names of the inventors listed herein.

### BACKGROUND OF THE INVENTION

The “front spindle” and the “tool spindle” of a Davenport automatic screw machine are designed to facilitate quick change of the cam tooling. Each spindle comprises a cam shaft and a cam carrier assembled end-to-end on a longitudinal mounting bolt and coupled for conjoint rotation by a key and mated recess formed on and in the confronting end portions. The tool spindle will usually additionally include a cam shaft extension disposed on the mounting bolt adjacent the cam carrier and similarly coupled thereto.

The interengaging key and recess extend transversely across the end portion of the respective spindle component, offset from the axis of rotation of the spindle so as to permit coupling in only one relative orientation. Bosses are formed on the confronting end portions, adjacent the key and recess as the case may be, so as to provide bearing surfaces for the assembled components.

In conventional spindle assemblies the transverse channel is usually on the end portion of the cam shaft component and the bosses are of arcuate form (effectively being elements of an interrupted annulus) and of substantially different lengths due to the axial offset of the channel; therefore, the areas of contact on opposite sides of the axis of rotation differ very substantially from one another. As a result, significantly unbalanced forces (i.e., a noncentralized force couple) are generated during rotation of the spindle assembly. This in turn produces bending moments and cyclical flexing of the mounting bolt, frequently leading to breakage of bolt threads and commonly causing undue wear of bushings and damage to other machine parts.

### SUMMARY OF THE INVENTION

Accordingly, it is the general object of the present invention to provide spindle assemblies and the like, particularly the front and tool spindles in Davenport automatic screw machines, wherein and whereby the unbalanced forces, and the attendant problems hereinabove described, are at least significantly reduced or virtually eliminated.

A more specific object of the invention is to provide a coupling end portion on the cam shaft and/or cam carrier of such a spindle assembly that is so constructed as to substantially balance the longitudinal forces acting therein on opposite sides of the axis of rotation.

It has now been found that the foregoing and related objects of the invention are attained by the provision at least one component of a spindle assembly (usually, the cam shaft) having a coupling end portion with contact elements disposed to opposite sides of a transverse channel or recess formed therein or an upstanding key formed thereon, which contact elements are dimensioned and configured for the transmission of substantially balanced longitudinal forces. Generally, the contact elements will be in the form of bosses, adjacent the recess and/or key, which have contact surfaces of substantially equal area and configuration; the bearing surfaces will preferably be in the form of arcuate bands, or annular sections.

The size and shape of the bosses on the coupling end portion of the cooperating spindle component are of less significance to the achievement of the objectives of the invention, provided of course that the bearing surfaces presented thereby receive the surfaces of the bosses of the adjacent component at least substantially completely and in substantially full surface contact. Thus, straight-line bosses will typically be employed on the cooperating component (usually, the cam carrier) so as to facilitate manufacture and minimize costs. The surface area thereof will usually be increased, however, as compared to a conventional part, by widening of the narrower boss so as to achieve optimal contact and coaction.

### BRIEF DESCRIPTION OF THE DRAWINGS

FIG. 1 is a transverse, vertical sectional view taken through the tool spindle section of a Davenport automatic screw machine;

FIG. 2 is an exploded elevational view of the main components of the tool spindle assembly depicted in FIG. 1, exclusive of the cam shaft extension;

FIG. 3 is an elevational view of the coupling end portion of the cam shaft component of the tool spindle assembly of the previous figures, drawn to a greatly enlarged scale and showing the conventional boss structure;

FIG. 4 is a view similar to FIG. 3, showing the novel boss structure provided in accordance with the present invention; and

FIG. 5 is a view analogous to that of FIGS. 3 and 4 but drawn to a reduced scale, showing the boss structure provided on the end portion of the cam carrier component of a spindle assembly, to which the end portion of the cam shaft component is coupled.

### DETAILED DESCRIPTION OF THE PREFERRED AND ILLUSTRATED EMBODIMENT

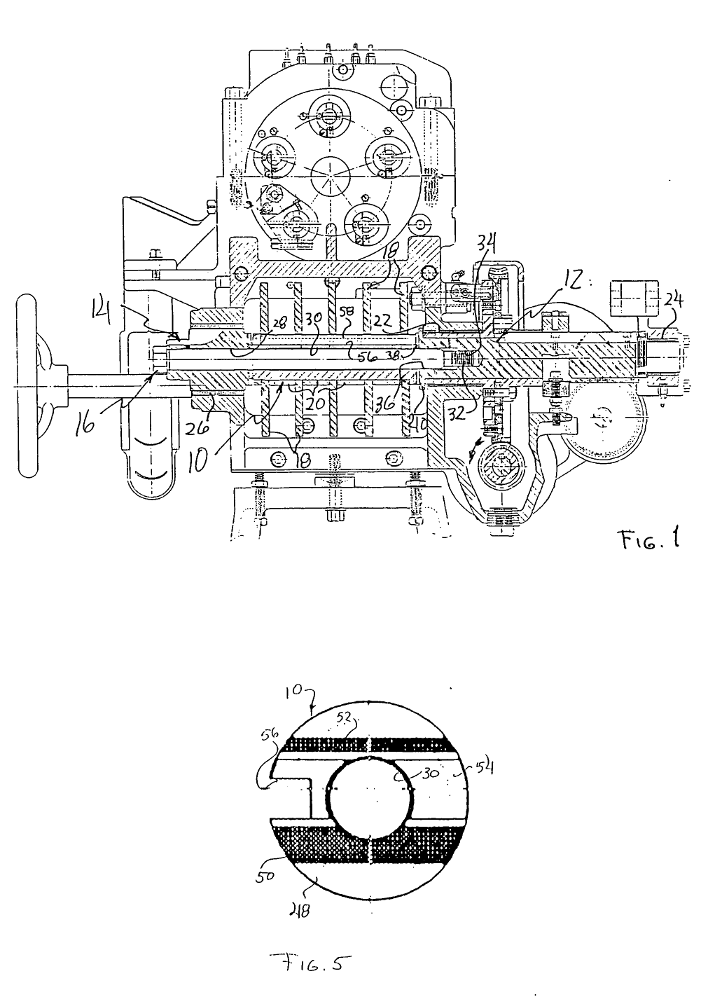

Turning now in detail to the appended drawings, FIG. 1 shows, in transverse, vertical cross section, the tool spindle section of a Davenport automatic screw machine. As seen therein, and in FIG. 2, the tool spindle assembly includes a cam carrier, a cam shaft, and a cam shaft extension (FIG. 1 only), generally designated respectively by the numerals 10, 12, and 14 and assembled on a mounting bolt generally designated by the numeral 16.

Cams 18 and spacers 20 are mounted upon the cam carrier 10. The opposite ends of the cam shaft 12 are received in bushings 22 and 24, and the cam shaft extension 14 is received in bushing 26. The mounting bolt 16 passes through the axial bores 28, 30 of the extension 14 and cam carrier 10, respectively, and has its threaded end portion 32 engaged in the matingly threaded portion 34 at the end of the blind bore 36 in the cam shaft 12.

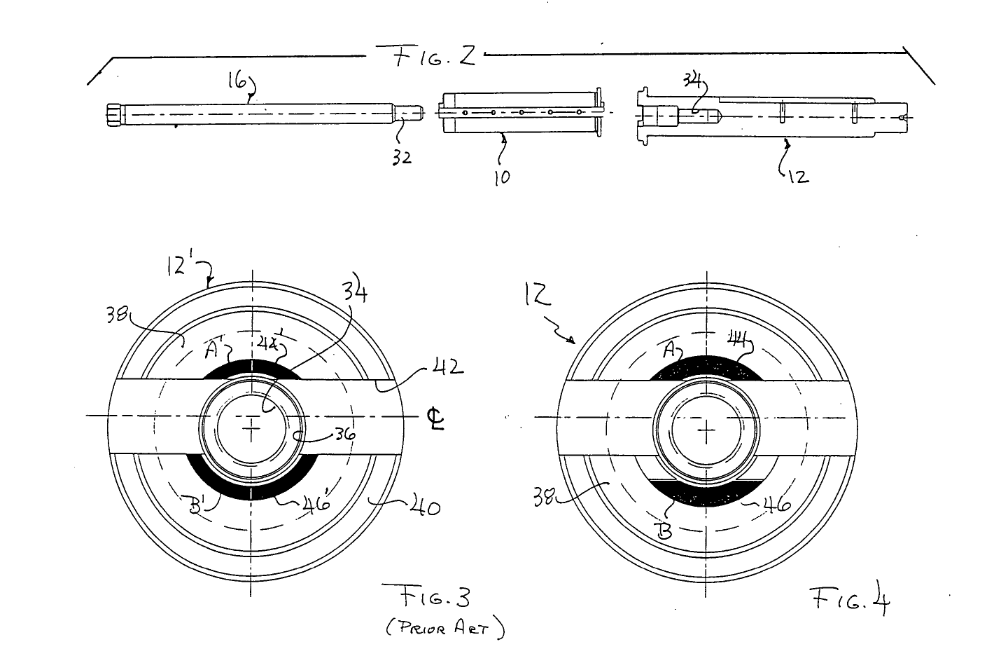

With particular reference now to FIGS. 3-5 of the drawings, FIGS. 3 and 4 depict the coupling end portion of a tooling spindle cam shaft (prior art structure, and features thereof, are designated in FIG. 3 with primed numbers). The end portion of the cam shaft comprises a circular hub 38 surrounded by an annular flange 40, across which hub extends a straight channel or recess 42, the centerline of which is offset from that of the bore 34 (i.e., displaced from the axis of spindle rotation), as described hereinabove.

The arcuate bosses 44′ 46′ depicted in FIG. 3 extend slightly above the surface of the hub 38 and are, as can be seen, of substantially different arcuate lengths; the shorter boss 44′ provides a bearing contact surface designated A′ which is of substantially smaller area than the surface B′ provided by the longer boss 46′. This contact surface area differential is responsible for producing the unbalanced forces, and noncentralized force couple, described hereinabove.

In contrast, and while being otherwise similar to the conventional bosses, the corresponding bosses 44, 46, formed on the hub 38 of the cam shaft component 12 provide, in accordance with the present invention, contact bearing surfaces A and B that are the same in size, shape and area. As a result, the longitudinal forces transmitted to the opposite sides of the axis of rotation are at least substantially equal, thereby greatly reducing, or eliminating entirely, asymmetric stresses, bending moments, and flexure, and thus satisfying the objects of the invention hereinabove set forth.

In addition, the total bearing surface area presented by these bosses is significantly and desirably increased, as compared to that of the analogous prior art construction. In a specific embodiment, for example, the total surface area presented by the bosses 44 and 46 is 0.3562 square inch (each being 0.1781 square inch), whereas the combined surface area of the bosses 44′, 46′ is 0.3337 square inch (0.1254 plus 0.2083 square inch). Generally, a surface area increase of at least five percent will desirably be provided.

FIG. 5 shows the coupling end portion of a coacting tool spindle cam carrier 10, which has a rectilinear key 54 extending transversely thereof and with its centerline offset from the axis of rotation of the spindle. The annular end portion 48 of the component 10 is formed with a relatively wide straight-line boss 50 and a relatively narrow straight-line boss 52, which are parallel to one another and extend along the sides of the key 54. A channel 56 extends lengthwise of the cam carrier 10 and serves to seat a long key 58 (see FIG. 1) by which the cam elements 18 are locked in place against rotation relative to the carrier.

A modification to the cam carrier component, made in accordance with the present invention, resides in the widening of the boss 52 so as to provide a total bearing contact surface of 0.779 square inch, as compared to 0.734 square inch in the conventional construction. The cam carrier component 10 is thereby adapted to coact most effectively with the embodiment of the cam shaft 12 hereinabove described, in implementation of the present invention.

It will be appreciated that specific boss surface areas are given hereinabove primarily for illustrative purposes. Other values will of course apply throughout the full range of structural variation encompassed by the disclosed concepts.

It will also be appreciated that, although the arcuate boss elements are provided on the cam shaft component of the tool spindle and adjacent the channel in the illustrated and preferred embodiment, they may instead be provided on the cam carrier component and adjacent a key or, indeed, upon both components. Comparable modifications will be made to a cam shaft extension, when included, and to the engaging end portion of the adjacent spindle component. Moreover, while the tool spindle assembly is specifically described herein, the innovations of the invention are of course equally applicable to the front spindle of the Davenport machine, and indeed to analogous assemblies in other machines, as may be effective to address problems of the nature discussed herein. Finally, whereas two bosses, disposed to opposite sides of the axis of rotation, are normally employed, other boss arrangements may be feasible as well to provide the force-balancing and centering condition sought. Additional variations and functional equivalents will occur to those skilled in the art, based upon the foregoing description, and should be deemed to fall within the scope of the instant invention.

Thus, it can be seen that the present invention provides novel spindle assemblies, particularly as used in Davenport automatic screw machines, wherein and whereby the unbalanced forces, and the attendant problems hereinabove described, are at least significantly reduced or avoided entirely. More specifically, a coupling end portion of at least one component of such a spindle assembly is so constructed as to substantially balance the longitudinal forces acting therein along opposite sides of the axis of rotation. In preferred embodiments, balance and force couple centering is achieved both by widening of the arcuate boss that is conventionally the shorter of the two, and also by shortening of the longer arcuate boss such that its ends terminate a substantial distance from the transverse recess or key, as the case may be, in the coupling end portion.

Having thus described the invention, what is claimed is:

1. A spindle assembly comprised of at least two elongate components assembled end-to-end and interengaged for conjoint rotation about a longitudinal axis with confronting end faces proximate one another, one of said end faces having an upstanding key extending transversely thereacross and the other of said end faces having a mated, traversely extending channel formed thereinto and engaging said key, said channel and key constituting coupling elements with centerlines offset from said axis of rotation, at least one of said end faces having at least one contact element disposed thereon to each of the opposite sides of said coupling element and providing a contact surface, said contact surfaces being dimensioned and configured for the transmission, to the other of said end faces, of substantially balanced longitudinal forces acting on opposite sides of said axis of rotation during rotation of said spindle assembly.

2. The assembly of claim 1 wherein said contact surface provided by said at least one contact element disposed to one of said opposite sides of said coupling element is of substantially the same area as said contact surface provided by said at least one contact element disposed to the other of said opposite sides of said coupling element.

3. The assembly of claim 2 wherein said contact surfaces on said opposite sides of said coupling element are of substantially the same configuration.

4. The assembly of claim 3 wherein said contact surfaces are in the form of annular sections.

5. The assembly of claim 1 wherein said contact elements are in the form of bosses.

6. The assembly of claim 1 wherein said coupling elements are rectilinear.

7. The assembly of claim 1 wherein said coupling element on said at least one end face is said transversely extending channel.

8. The assembly of claim 1 wherein said at least two components thereof are a cam shaft and a cam carrier.

9. The assembly of claim 8 wherein said at least one end surface is on said cam shaft.

10. The assembly of claim 8 wherein said assembly is for an automatic screw machine.

11. The assembly of claim 10 wherein said cam shaft is constructed to engage a mounting bolt in coaxial relationship thereto, and wherein said cam carrier has an axial bore therethrough dimensioned and configured to receive a mounting bolt extending from said cam shaft.

12. The assembly of claim 1 wherein the other of said end faces has a bearing surface thereon dimensioned and configured to receive at least substantially completely, and in substantially full surface contact, said contact surfaces of said contact elements on said at least one end face.

13. The assembly of claim 12 wherein said bearing surface on said other end face comprises a straight-line boss disposed to each of the opposite sides of said coupling element thereon and extending parallel thereto.

14. The assembly of claim 1 wherein said components have end portions in the form of circular hubs on which said confronting end faces are provided.
